(19) United States
(12) Patent Application Publication
(10) Pub. No.: US 2026/0064239 A1
(43) Pub. Date: Mar. 5, 2026

(54) AUTOMATIC PLACEMENT OF DIGITAL MEDIA WITHIN VIRTUAL EXPERIENCES

(71) Applicant: Roblox Corporation, San Mateo, CA (US)

(72) Inventors: Swapnil RALHAN, San Mateo, CA (US); Richard SIM, Emerald Hills, CA (US); Karun CHANNA, Redwood City, CA (US)

(73) Assignee: Roblox Corporation, San Mateo, CA (US)

(21) Appl. No.: 19/284,293

(22) Filed: Jul. 29, 2025

Related U.S. Application Data
(60) Provisional application No. 63/690,402, filed on Sep. 4, 2024.

(51) Int. Cl. G06F 3/04815; G06F 3/0482; G06T 15/08; G06T 19/00

(52) U.S. Cl. CPC G06F 3/04815; G06F 3/0482; G06T 15/08; G06T 19/00; G06T 2200/24

(57) ABSTRACT

Some implementations relate to methods, systems, apparatuses, and computer-readable media for automatic digital media placement within a virtual experience provided at a virtual experience platform. Spatial telemetry of avatars is tracked during a time window and stored in an engagement heatmap comprising three-dimensional voxels, each representing a subsection of the virtual experience. Each voxel includes a size value representing the number of avatars and an intensity value representing the magnitude of telemetry. Voxels are ranked based on size and intensity, and a target demographic and relevant subsections are identified. Digital media is automatically selected and placed at subsections associated with voxels that exceed an engagement threshold. The placement is performed outside the telemetry collection window and is configured to be viewable by avatars associated with the target demographic.

### CROSS-REFERENCE TO RELATED APPLICATIONS

This application claims priority to U.S. Provisional Patent Application No. 63/690,402, filed Sep. 4, 2024, and titled “AUTOMATIC DIGITAL ADVERTISING PLACEMENT WITHIN VIRTUAL EXPERIENCES,” the entire contents of which are incorporated by reference herein.

### TECHNICAL FIELD

Embodiments relate generally to online virtual experience platforms, and more particularly, to methods, systems, and computer readable media for automatic digital media placement within virtual experiences.

### BACKGROUND

Online platforms, such as virtual experience platforms and online gaming platforms, can sometimes include digital media, including, for example, media to promote virtual items that users can purchase or other items. However, it can be difficult to determine an appropriate placement of a piece of digital media to improve a level of engagement or reduce a level of distraction of the users based on the media. For example, depending upon placement of a piece of digital media within a virtual environment of a virtual experience, users may not congregate or view the piece of digital media if in a heavily trafficked area, users may find the piece of digital media distracting, users may find the piece of digital media difficult to view, and/or the placement of the digital media may suffer other drawbacks. Additionally, when presenting a piece of digital media, it can also be difficult to determine the level of engagement or distraction of the users viewing the media in order to determine proper placement. Furthermore, it can be difficult to retain or improve user enjoyment within a virtual experience platform based on display or playback of digital media which may detract from immersion of a user in a virtual environment.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of this disclosure are directed to methods, systems, and computer readable media to provide automatic placement of digital media within virtual experiences.

According to an aspect, a computer-implemented method of presenting digital media within a virtual experience provided at a virtual experience platform is disclosed, the method comprising: tracking spatial telemetry of a plurality of avatars within the virtual experience during a time window; storing spatial telemetry data of the tracked spatial telemetry at individual time-slices of the time window in an engagement heatmap, wherein the engagement heatmap includes a data structure comprising a plurality of three-dimensional (3D) voxels, each voxel corresponding with a respective subsection of the virtual experience, and the stored spatial telemetry data comprises, for each voxel, a voxel size value that represents a number of individual avatars having spatial telemetry data associated with a particular voxel, and a voxel intensity value that represents a magnitude of spatial telemetry data associated with the particular voxel; ranking individual voxels of the engagement heatmap based on a respective voxel size values and a respective voxel intensity value; identifying a target demographic and individual subsections of the virtual experience trafficked by the target demographic based on the engagement heatmap; identifying individual voxels that exceed an engagement threshold based on the ranked individual voxels and the identified target demographic; automatically selecting digital media for placement in the virtual experience and viewable by the identified target demographic based on the identified individual voxels; and placing the selected digital media at the identified individual subsections of the virtual experience wherein members of the target demographic are associated with a respective member avatar in the virtual experience, and wherein the placing is performed at a time outside the time window.

In some implementations, the method further comprises: detecting that the member avatar is within a threshold distance of a first piece of digital media content of the placed selected digital media; causing the first piece of digital media to be displayed in the virtual experience while the member avatar is within the threshold distance; determining engagement of the member avatar with the first piece of digital media based on interaction between the member avatar and the first piece of digital media in the virtual experience; assigning a user engagement metric to the first piece of digital media based on the engagement; and appending the user engagement metric to at least one voxel of the engagement heatmap as a voxel engagement value, wherein the at least one voxel is within the identified individual subsections of the virtual experience.

In some implementations, the individual time-slices are evenly distributed time-slices of the time window, and include at least two time-slices.

In some implementations, the engagement heatmap is a first engagement heatmap, wherein the time window is a first time window, and wherein the computer-implemented method further comprises: tracking spatial telemetry of a plurality of avatars within the virtual experience during a second time window; and storing spatial telemetry data of the tracked spatial telemetry at individual time-slices of the second time window in a second engagement heatmap.

In some implementations, the method further comprises: appending the second engagement heatmap to the first engagement heatmap to obtain a new engagement heatmap; and updating placement of the selected digital media based on the new engagement heatmap.

In some implementations, the method further comprises: appending the second engagement heatmap to the first engagement heatmap to obtain a new engagement heatmap; and replacing the placed selected digital media by: ranking individual voxels of the new engagement heatmap based on a respective voxel size value and a respective voxel intensity value; identifying a new target demographic and new individual subsections of the virtual experience trafficked by the new target demographic based on the new engagement heatmap; identifying new individual voxels that exceed the engagement threshold based on the ranked individual voxels and the identified new target demographic; automatically selecting new digital media for placement in the virtual experience and viewable by the new identified target demographic based on the new identified individual voxels; and placing the selected new digital media at the identified new individual subsections of the virtual experience.

In some implementations, the stored spatial telemetry data further comprises one or more of: a camera view value that represents a camera view size of a respective avatar; a camera orientation value that represents a camera orientation of a respective avatar; a demographic value that represents a respective demographic of a user of the virtual experience platform associated with a respective avatar; a social value that represents social connections of a respective avatar; a user type value that represents a type of user associated with a respective avatar; context data that represents a context of engagement of a respective avatar within the virtual experience; and combinations thereof.

In some implementations, the method further comprises: presenting, at a user interface, the engagement heatmap as a graphic with selectable elements associated with the identified individual subsections of the virtual experience; and displaying, based on received selections of the selectable elements, spatial telemetry data associated with individual voxels corresponding to the identified individual subsections of the virtual experience.

In some implementations, the method further comprises altering the placed selected digital media based on the received selections of the selectable elements.

In some implementations, placing the selected digital media is further based on the received selections of the selectable elements.

According to another aspect, a system is disclosed, comprising: a memory with instructions stored thereon; one or more processing devices, coupled to the memory, the one or more processing devices configured to access the memory and execute the instructions to perform operations including: tracking spatial telemetry of a plurality of avatars within a virtual experience during a time window; storing spatial telemetry data of the tracked spatial telemetry at individual time-slices of the time window in an engagement heatmap, wherein the engagement heatmap includes a data structure comprising a plurality of three-dimensional (3D) voxels, each voxel corresponding with a respective subsection of the virtual experience, and the stored spatial telemetry data comprises, for each voxel, a voxel size value that represents a number of individual avatars having spatial telemetry data associated with a particular voxel, and a voxel intensity value that represents a magnitude of spatial telemetry data associated with the particular voxel; ranking individual voxels of the engagement heatmap based on a respective voxel size values and a respective voxel intensity value; identifying a target demographic and individual subsections of the virtual experience trafficked by the target demographic based on the engagement heatmap; identifying individual voxels that exceed an engagement threshold based on the ranked individual voxels and the identified target demographic; automatically selecting digital media for placement in the virtual experience and viewable by the identified target demographic based on the identified individual voxels; and placing the selected digital media at the identified individual subsections of the virtual experience wherein members of the target demographic are associated with a respective member avatar in the virtual experience, and wherein the placing is performed at a time outside the time window.

In some implementations, the operations further comprise: detecting an avatar of the plurality of avatars within a threshold distance of a first piece of digital media of the placed selected digital media, the avatar being associated with a user, wherein the user is associated with the identified target demographic; presenting the first piece of digital media content for viewing by the avatar; tracking an engagement of an avatar with the presented first piece of digital media, wherein the engagement of the avatar is a measure of an interaction of an avatar with the presented first piece of digital media; assigning a user engagement metric to the presented first piece of digital media based upon the tracking of engagement of the avatar; and appending the user engagement metric to at least one voxel of the engagement heatmap as a voxel engagement value.

In some implementations, the individual time slices are evenly distributed time slices of the time window.

In some implementations, the engagement heatmap is a first engagement heatmap, wherein the time window is a first time window, and wherein the operations further comprise: tracking spatial telemetry of a plurality of avatars within the virtual experience during a second time window; and storing spatial telemetry data of the tracked spatial telemetry at individual time-slices of the second time window in a second engagement heatmap.

In some implementations, the operations further comprise: appending the second engagement heatmap to the first engagement heatmap to create a new engagement heatmap; and arranging the selected digital media for automatic viewing by members of the target demographic based on the new engagement heatmap.

In some implementations, the operations further comprise: appending the second engagement heatmap to the first engagement heatmap to create a new engagement heatmap; and replacing the placed selected digital media by: ranking individual voxels of the new engagement heatmap based on a respective voxel size value and a respective voxel intensity value; identifying a new target demographic and new individual subsections of the virtual experience trafficked by the new target demographic based on the new engagement heatmap; identifying new individual voxels that exceed the engagement threshold based on the ranked individual voxels and the identified new target demographic; automatically selecting new digital media for placement in the virtual experience and viewable by the new identified target demographic based on the new identified individual voxels; and placing the selected new digital media at the new identified individual subsections of the virtual experience.

In some implementations, the stored spatial telemetry data further comprises one or more of: a camera view value that represents a camera view size of a respective avatar; a camera orientation value that represents a camera orientation of a respective avatar; a demographic value that represents a user demographic of a respective avatar; a social value that represents social connections of a respective avatar; a user type value that represents a type of user associated with a respective avatar; and context data that represents a context of engagement of a respective avatar within the virtual experience.

In some implementations, the operations further comprise: presenting, at a user interface, the engagement heatmap as a graphic with selectable elements associated with the identified individual subsections of the virtual experience; and displaying, based on received selections of the selectable elements, spatial telemetry data associated with individual voxels corresponding to the identified individual subsections of the virtual experience.

In some implementations, the operations further comprise: altering the arranged selected digital media based on the received selections of the selectable elements.

According to another aspect, a non-transitory computer-readable medium is disclosed with instructions stored thereon that, responsive to execution by a processing device, causes the processing device to perform operations comprising: tracking spatial telemetry of a plurality of avatars within a virtual experience during a time window; storing spatial telemetry data of the tracked spatial telemetry at individual time-slices of the time window in an engagement heatmap, wherein the engagement heatmap includes a data structure comprising a plurality of three-dimensional (3D) voxels, each voxel corresponding with a respective subsection of the virtual experience, and the stored spatial telemetry data comprises, for each voxel, a voxel size value that represents a number of individual avatars having spatial telemetry data associated with a particular voxel, and a voxel intensity value that represents a magnitude of spatial telemetry data associated with the particular voxel; ranking individual voxels of the engagement heatmap based on a respective voxel size values and a respective voxel intensity value; identifying a target demographic and individual subsections of the virtual experience trafficked by the target demographic based on the engagement heatmap; identifying individual voxels that exceed an engagement threshold based on the ranked individual voxels and the identified target demographic; automatically selecting digital media for placement in the virtual experience and viewable by the identified target demographic based on the identified individual voxels; and placing the selected digital media at the identified individual subsections of the virtual experience wherein members of the target demographic are associated with a respective member avatar in the virtual experience, and wherein the placing is performed at a time outside the time window.

According to yet another aspect, portions, features, and implementation details of the systems, apparatuses, devices, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram of an example system architecture to implement automatic placement of digital media, in accordance with some implementations.

FIG. 3A is an isometric view of a virtual environment of a virtual experience, in accordance with some implementations.

FIG. 3B is an isometric view of a heatmap based on the virtual environment of FIG. 3A, in accordance with some implementations.

FIG. 3C is a planar view of the heatmap of FIG. 3B, in accordance with some implementations.

FIG. 4A is a schematic of a user interface for automatic placement of digital media, in accordance with some implementations.

FIG. 4B is a perspective view of an automatically placed and tracked digital media element, in accordance with some implementations.

FIG. 5 is a flowchart of an example method of automatic placement of digital media, in accordance with some implementations.

FIG. 6 is a flowchart of an example method to track digital media display and engagement, in accordance with some implementations.

FIG. 7 is a flowchart of an example method to stream heatmap data, in accordance with some implementations.

FIG. 8 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

In some aspects, systems and methods are provided for automatic placement of digital media within a virtual experience. Online platforms, such as online virtual experience platforms, generally provide an ability to create, store, promote, and present for purchase virtual items to be used in virtual experiences.

For example, the virtual experience platforms may include user-generated content or developer-generated content (each referred to as “UGC” herein). The UGC may be stored and implemented through the virtual experience platforms, for example, by allowing users to search and interact with various virtual experiences and associated virtual items. Virtual items may be presented in a search interface or inventory screen, whereby users may peruse one or more virtual items, search for new virtual items, and/or purchase one or more virtual items prior to entering a virtual experience.

While search interfaces and inventory screens allow users to search for items, virtual experiences provide an immersive experience for a user. For example, avatars may move about virtual experiences and interact with a plurality of virtual items in a typical virtual experience.

Various implementations described herein may provide automatic placement of digital media, within a first virtual experience, that can be tracked, audited, and altered. Various recommendations for digital media placement may be implemented based upon tracked spatial telemetry data, among other data.

According to implementations and embodiments described herein in detail, an online virtual experience platform may deploy a digital media component at a server that is configured to generate an engagement heatmap based upon tracked spatial telemetry data. The spatial telemetry data may be tracked during individual time-slices or time windows, and may be based upon movements of virtual avatars within a virtual experience. The spatial telemetry data may be stored in the engagement heatmap, and may include any available spatial telemetry including avatar field of view, avatar camera data, avatar direction, avatar motion, and other data.

The engagement heatmap may be arranged such that individual voxels of the engagement heatmap represent both a size (e.g., a number of unique avatars within a voxel per time-slice shown as an increase in size of a voxel) and an intensity (e.g., magnitude of interactions shown as increasing/decreasing intensity or numerical weights per voxel). The engagement heatmap may be assembled in a streaming manner, through aggregation and appending of individual heatmaps or sub-portions of heatmaps, into a larger heatmap. The engagement heatmap may provide useful visual data to developers and/or users based upon highly trafficked areas of individual virtual experiences, as well as provide a basis for automatic placement of digital media as described herein.

Additionally, the digital media component may deploy one or more pieces of digital media within one or more virtual experiences based on automatic placement and/or automatic recommendations. The digital media component, based on selectable options and user-permitted user profile data, may provide digital media relating to virtual items in an interactive, engaging, and suitable experience depending upon relevant user data. The digital media component, based on avatar engagement or interaction, may provide digital media for viewing by an avatar in an immersive virtual experience. Media may be viewed by multiple avatars simultaneously, in some implementations, with each avatar being provided their own view of the digital media, such that a view from one avatar of digital media of another avatar may be obfuscated or hidden. In this manner, many different pieces of digital media may be tracked simultaneously on a per-user basis. Furthermore, multiple avatars may interact with different digital media for which engagement metrics are tracked. These and other suitable example embodiments will become apparent in this disclosure.

It is noted that any use of user and/or developer data to track spatial telemetry data and/or to determine interests of users, identify matching items, or any other purpose is specifically with permission from the user, in accordance with applicable regulations, and can be turned off by the user. Users can also choose what data to permit for such use. User data is stored securely and in compliance with rules and laws. Furthermore, data collection is not performed in certain geographic locales, for certain user categories (e.g., based on age or other demographic), is temporary (data are discarded after a period of time), and data is stored securely even when only used temporarily. Moreover, user data are not shared with third-parties without explicit user permission. Even further, some data may be anonymized, aggregated across users, or otherwise modified so that a specific user identity cannot be determined.

Hereinafter, further details surrounding example embodiments and various aspects of this disclosure are described with reference to the figures.

### System Architecture

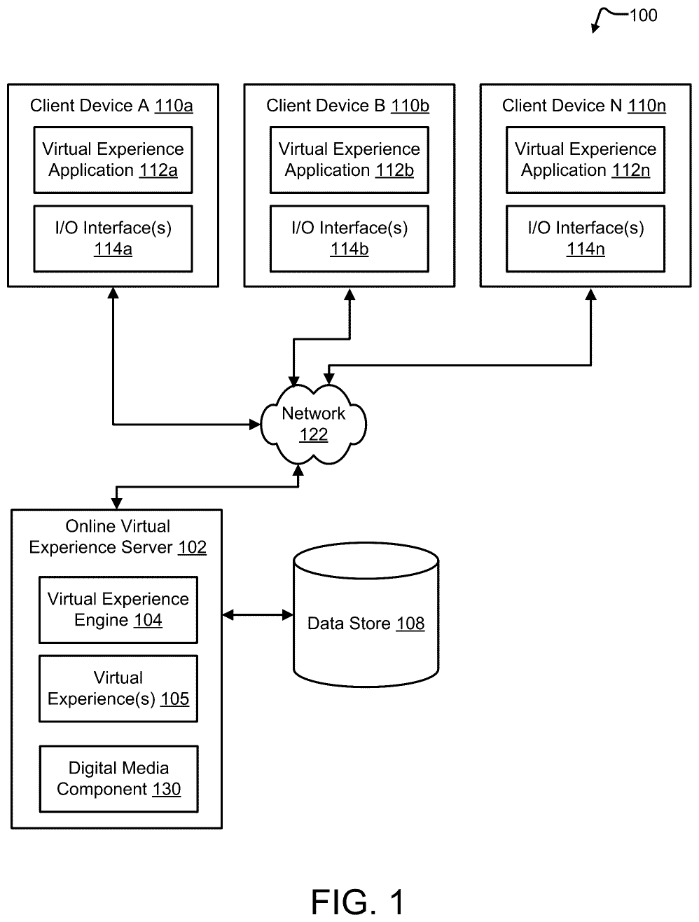

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third-party server 118, all coupled via a network 122.

The online virtual experience server 102 can include, among other things, a virtual experience engine 104, one or more virtual experiences 105, and a digital media component 130. The online virtual experience server 102 may be configured to provide virtual experiences 105 to one or more client devices 110, and to provide interactive digital media via the digital media component 130, in some implementations.

Data store 108 is shown coupled to online virtual experience server 102 but in some implementations, can also be provided as part of the online virtual experience server 102. The data store may, in some implementations, be configured to store media data, user data, engagement data, and/or other contextual data in association with the digital media component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include digital media elements as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience and in association with the digital media component 130, an avatar of a user may view an interactive piece of digital media, including digital video-based media. In some embodiments, using data related to context, prior user interactions, and prior user engagement with various virtual experiences, the digital media may promote one or more virtual items that may be of interest to the user, may present video-based media related to an experience or third-party content, and others.

A location of an avatar, viewpoint of an avatar, perspective of an avatar, and time spent viewing different aspects of a virtual experience or virtual environment of an avatar may all be used to generate heatmap data with the digital media component 130 and/or other components of the platform 100. Additionally, after ad placement, the avatar location, viewpoint, perspective, and time spent viewing/interacting with media may be used to track media impressions as described herein with the digital media component 130 and/or other components of platform 100.

In some implementations, the digital media component 130 may provide control and provisioning of digital media within virtual experiences served by the online virtual experience platform 100. For example, a piece of digital media may be viewed by an avatar, and automatically altered, paused, resumed, etc., depending upon interaction of the avatar with the digital media.

The digital media component 130 may also collect telemetry data which may include a user identifier, avatar description, demographical information, and others. In situations in which these and other certain implementations discussed herein may obtain or use user data (e.g., images of user avatars, user demographics, user profile data, user self-description, etc.) users are provided with options to control whether and how such information is collected, stored, or used. That is, the implementations discussed herein collect, store and/or use user information upon receiving explicit user authorization and in compliance with applicable regulations.

Furthermore, users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed.

The digital media component 130 may generate an engagement heatmap based upon tracked spatial telemetry data of avatars interacting within a virtual experience (VE) 105, for example. The spatial telemetry data may be tracked during individual time-slices or time windows, and may be based upon movements of virtual avatars within the VE 105. The spatial telemetry data may be stored in the engagement heatmap, and may include any available spatial telemetry including avatar field of view, avatar camera data, avatar direction, avatar motion, and other data. For example, by leveraging both avatar viewpoints and camera data (as well as other available direction data), the digital media component 130 may generate a heatmap that provides for faster determination of avatar interaction intensity for any particular area of the VE 105, and may therefore provide basis for relatively rapid media recommendations.

For example, as the engagement heatmap includes spatial telemetry data as well as user demographics, user interaction history, and others, the digital media component 130 may provide automatic placement of digital media according to weights and sizes of voxels in the heatmap. Furthermore, by leveraging camera angle, avatar viewpoint, and other direction data, automatic placement of digital media may further include proper media orientation based on the engagement heatmap. These and other features may reduce computational loads (e.g., by having pre-assembled or partially assembled heatmaps, there are less computations for initial placement of digital media), may reduce network bandwidth (e.g., by having some computations based on client devices tracking movements and assembling partial heatmaps, unnecessary data transmissions may be reduced), and may improve user interaction with the platform 100 (e.g., with better media placement and orientation, users may be less distracted by media and/or may find media in appropriate placement for engagement rather than obstructing game-play or other interactions).

The engagement heatmap may be arranged such that individual voxels of the engagement heatmap represent both a size (e.g., a number of unique avatars within a voxel per time-slice shown as an increase in size of a voxel) and an intensity (e.g., magnitude of interactions shown as increasing/decreasing intensity or numerical weights per voxel). The engagement heatmap may provide useful visual data to developers and/or users based upon highly trafficked areas of individual virtual experiences, as well as provide a basis for automatic digital media placement as described herein. These and other features may provide for reduced effort in generating and deploying a digital media campaign, which may result in fewer computations in deploying a digital media campaign (e.g., by resulting in less redundancy in viewing different numerical metrics), reduced network bandwidth (e.g., by resulting in less cycles of media replacement and testing), as well as reduced time spent viewing other media and user metrics through presentation of the heatmap (or heatmaps and/or portions thereof) in graphical user interfaces.

Additionally, the digital media component 130 may deploy one or more pieces of digital media within one or more virtual experiences based on automatic placement and/or automatic recommendations. The digital media component 130, based on selectable options and user-permitted user profile data, may provide digital media relating to virtual items in an interactive, engaging, and suitable experience depending upon relevant user data. The digital media component, based on avatar engagement or interaction, may provide digital media for viewing by an avatar in an immersive virtual experience. Media may be viewed by multiple avatars simultaneously, in some implementations, with each avatar being provided their own view of the digital media, such that a view from one avatar of digital media of another avatar may be obfuscated or hidden. In this manner, many different pieces of digital media may be tracked simultaneously on a per-user basis and may provide further technical benefits and advancements including assembly of richer engagement data per individual piece of digital media, while resulting in less computational resources for tracking media impressions.

Upon placement of digital media, the digital media component 130 may also receive indications that particular avatars are within a threshold distance of digital media elements and may present media (e.g., selected piece of digital media for each user based on one or more characteristics of users associated with the particular avatars) on the elements. The digital media that is presented may be different depending upon which avatar is viewing the media element. For example, two different avatars that are viewing the same digital media element within the same virtual experience may see the same or different piece of digital media (or other content) on the digital media element, depending upon an associated demographic and other considerations. For example, the piece of digital media may be tailored based on various user-permitted data regarding the users associated with each avatar, such as demographic data (e.g., age, location, gender), activity data within the virtual experience, e.g., prior items purchased, items engaged with, avatar configuration, items that the avatar viewed previously, items that other avatars that are linked to the particular avatar (e.g., friends on the virtual experience platform) engaged with, etc., or from other virtual experiences on the virtual experience platform, etc.

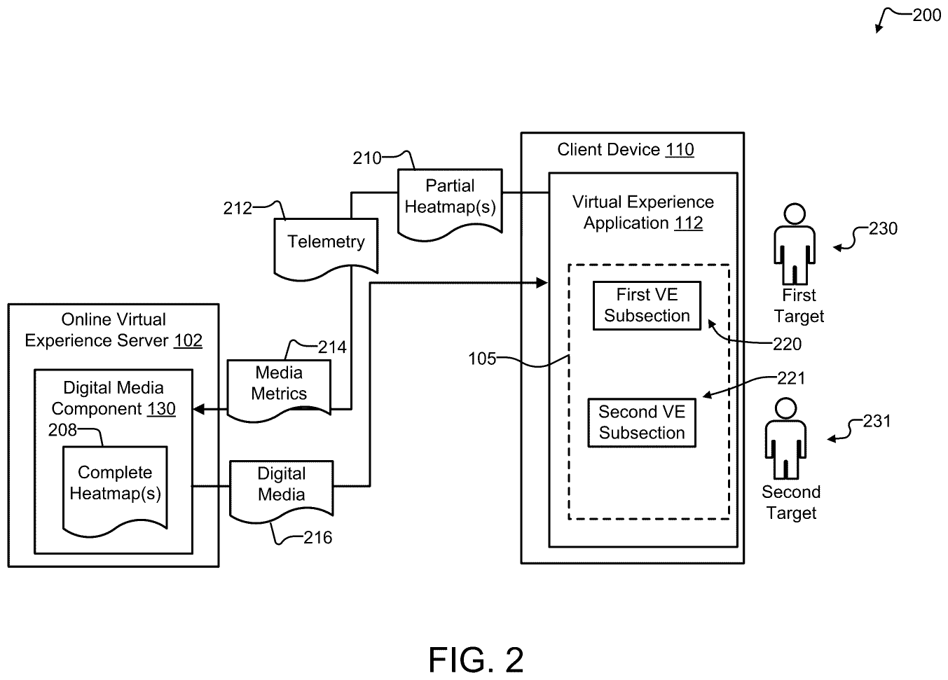

Hereinafter, an example flow of automatic placement of digital media is described with reference to FIG. 2.

### Digital Media Architecture

FIG. 2 is a diagram of an example system architecture 200 to implement automatic placement of digital media, in accordance with some implementations.

The system architecture 200 (also referred to as a “sub-system” herein) includes the online virtual experience server 102, digital media component 130, and client device 110 executing virtual experience application 112. Online virtual experience server 102 and client device 110 may be arranged as described above with reference to FIG. 1, namely, in operative communication over network 122 (omitted here for clarity).

In some implementations, a complete heatmap 208 may be assembled for virtual experience (VE) 105. For example, individual avatars of a first demographic 230 and a second demographic 231 may be tracked. The tracking may include storage of spatial telemetry data for individual avatars, such as, for example, location, speed, motion, camera view, camera orientation, size of view, and others. The spatial telemetry data may be tracked on a per-user basis, on a per-experience basis, on a per-instance basis (e.g., per instance of a virtual experience executing on a server or device), and/or on other unit bases. The heatmap 208 may include a data structure storing these and other tracked data.

In some implementations, individual subsections 220 and 221 of the VE 105 are tracked and sub-portions of the heatmap 208 are streamed as partial heatmaps 210. For example, the client device 110 may be arranged to track avatar spatial telemetry data for a user associated with the client device 110, and prepare a partial heatmap 210 for transmission to the digital media component 130.

In some implementations, individual subsections 220 and 221 of the VE 105 are tracked and sub-portions of the heatmap 208 are streamed as partial heatmaps 210. For example, the client device 110 may be arranged to track avatar spatial telemetry data for a cohort of associated users 230 within the subsection 220, and prepare a partial heatmap 210 for transmission to the digital media component 130.

In some implementations, individual subsections 220 and 221 of the VE 105 are tracked and telemetry data 212 is used to generate the heatmap 208. For example, the client device 110 may be arranged to track avatar spatial telemetry data for a user, cohorts of users, or other groups associated with the client device 110, and prepare telemetry data 212 for transmission to the digital media component 130.

In some implementations, the digital media component 130 may be configured to append any number of partial heatmaps 210 to create the heatmap 208. In some implementations, the digital media component 130 may be configured to append telemetry data 212 to heatmap 208 in a streaming manner, or upon receipt of new data, as well as append partial heatmaps thereto. In this manner, the digital media component 130 may assemble different data, including telemetry and partial heatmaps, in generating the heatmap 208. Other variations may also be applicable.

In an example, a party may create one or more pieces of digital media 216 for deployment and use in a virtual experience. The digital media 216, as well as any specified settings for media, may be input into the digital media component 130. Several specified settings may be used. For example, a creator of the digital media 216 may specify an amount of currency, virtual currency, or payment they would pay for X number of views, an amount of currency they would pay for Y number of try-ons, an amount of currency for Z number of purchases, and/or if the virtual item or third-party item is to be promoted to a particular type of user, subscriber, only premium users, or on another basis. For example, the creator of the digital media 216 may also specify user or avatar rewards which may be granted to a user account associated with an avatar, based on particular media impression metrics and/or user engagement metrics with the digital media 216 and/or other engagement metrics, demographic considerations, and others.

The digital media component 130 may take as input the digital video-based media 216 and specified settings for media, and create a media profile for the respective party and digital media 216 combination. For example, the party may indicate one or more settings for media based upon any suitable media profile. In some implementations, the settings of the party may include configurable keywords or other data that specify which items they do not want the digital media component 130 to display, configurable keywords or other data that specify which items they want the digital media component 130 to display, minimum or maximum age thresholds for media, minimum or maximum gameplay hours for media, min/max number of items to promote, radius of geo-fence (e.g., distance of an avatar from a digital media element) to trigger the media display, min/max number of users in the geo-fence to trigger the ad display, target demographics, and/or other media settings.

The media settings may also be controlled and/or overridden by more restrictive media campaign controls for a media item (such as a virtual experience, game, product, brand, multiple associated brands, movie, film, sports team match, or other media items). The media item may be produced by a separate party (e.g., from a promoter, distributor, or creator of digital media) and may include any suitable media item that is subject of a media campaign.

The digital media component 130 may compare the complete heatmap 208 (or portions thereof) to the media profile, and determine at least one placement for the digital media 216 that meets the media profile requirements. For example, data from the heatmaps may be used to determine if any particular voxels associated with the VE 105 meet or exceed requirements in the media profile. Upon identification of the at least one placement, the digital media 216 may be automatically placed in the VE 105 at the determined placement.

In another example, the heatmap 208 may be analyzed to determine if individual voxels meet or exceed thresholds for digital media placement. Spatial telemetry data (e.g., avatar positioning, viewport view, motions, etc.), user data (e.g., demographics, age, gender, etc.), and other data may be used for voxel ranking based on thresholds. For example, suitable thresholds may include a number of avatars viewing the same direction in an area having a threshold amount of avatar movement. Suitable thresholds may also include a number of avatars meeting demographic requirements in an area having less than a threshold amount of other demographics present during a time slice. These and other thresholds may be varied in many ways. For example, different targeted user groups, cohorts, directions, view sizes, and others can be considered when ranking individual voxels of the heatmap.

Upon ranking individual voxels of the heatmap 208, the digital media component 130 may select a piece of digital media 216 based on the calculated data for the ranked voxels, and present options to a developer or media creator for placement. For example, a graphical user interface (GUI) may be presented such that a developer of the VE 105 may select final placement of the piece of digital media 216 based on any chosen options and/or selections. In some implementations, an automatic placement based on ranked voxels may also be applicable, depending upon developer settings and/or preferences.

After placement of one or more pieces of digital media 216 in one or more areas of the VE 105, the digital media component 130 may be configured to determine engagement metrics for the individual pieces of digital media that were placed.

The digital media component 130 may receive indication or detect that an avatar is participating in a first virtual experience 105 through the virtual experience application 112. The indication may include indication that the avatar associated with a first user identifier (ID) is within a threshold radius (or within a geo-fence) of a digital media element that is located within the first virtual experience 105. The indication may also include an indication of avatar context.

For example, avatar context refers to spatial telemetry data, user data, and other data which indicates the context in which the avatar is interacting within a virtual experience. Examples of avatar context may include, but are not limited to: readiness for digital video viewing (e.g., if an avatar is positioned to view a digital billboard or virtual monitor display, etc.), engagement with virtual items (e.g., an avatar picking up a virtual soccer ball may be interested in viewing a trailer for a new movie related to soccer or sports, etc.), engagement with virtual environment (e.g., an avatar visiting multiple activities in a virtual environment may be interested in viewing a piece of video-based media for other activities in a virtual environment). Spatial telemetry data (e.g., avatar positioning, viewport view, motions, etc.), user data (e.g., demographics, age, gender, etc.), and other data may be used to determine these and other forms of avatar context and readiness to view digital video-based media.

In some implementations, in response to detecting that an avatar is within the threshold radius and based on avatar context, the digital media component 130 may display a particular piece of digital media 216 at the digital media element. The displayed piece of digital media 216 may include a banner, image, or moving picture associated with the user preferences associated with the avatar. For example, age-specific restrictions may be applied in selecting and displaying the particular piece of digital media. Other restrictions may also be applicable, including geographic and/or locale-specific restrictions, time-specific restrictions, etc.

In some implementations, a static image representative of the piece of digital video-based media may be displayed prior to playback of any digital video. In this manner, user interest in the displayed static image may help improve avatar context determinations by tracking avatar spatial telemetry data relative to the static image.

By approaching, e.g., walking towards (or flying, driving, riding, sailing, or via any other movement) to be within the threshold distance of the piece of digital media 216, the avatar may be displayed the particular piece of digital media 216, based upon determined avatar context and other data.

In some implementations, upon interaction by the avatar with the piece of digital media 216, media metrics 214 (e.g., such as engagement metrics, purchases, try-ons of virtual items, and others) may be tracked as impressions and/or partial impressions for the piece of digital media 216 displayed to the particular avatar. The media metrics 214 may be stored for the particular piece of digital media, and may be used in media revenue calculations, adjustments to the heatmap 208, and others.

In some implementations, an avatar may select one or more virtual items to interact with or purchase. If the avatar has selected a virtual item to interact with or try on (e.g., if the item is a piece of clothing or accessories that can be worn by the avatar), the digital media component 130 may temporarily allow the avatar to appear as if the virtual item is worn. If the avatar issues a selection to purchase the virtual item, the selection is processed by the digital media component 130 to effectuate the purchase. Thereafter, the avatar may be granted use of the purchased virtual item and the item placed into an item inventory associated with the corresponding user on the virtual experience platform. In some implementations, physical items may be purchased based on the displayed pieces of digital video media (e.g., movie tickets for a trailer that was played, soccer tickets for a promotional soccer video that was played, and so on).

Upon successful purchase (or based on a digital media viewing criterion being met, e.g., to qualify as an impression), the digital media component 130 may also determine an associated monetization amount to be transferred to the associated developer account. The monetization amount may be in the form of virtual currency, in some implementations.

It is noted that media publishers (e.g., creators, distributors, or owners of digital media) may also receive revenue through use of digital media as described herein. In some implementations, media publishers place a bid for a price (e.g., maximum price) they are willing to pay per unique player or avatar. In some implementations, media publishers may pay a cost per valid impression. In some implementations, media publishers may pay a cost per unique impression from individual avatars if the media is viewed by more than one avatar. In some implementations, media publishers may pay a cost per completed view (for video-based media), cost per play (for interactive media), cost per view duration threshold (for video-based, interactive, and dynamic media), and based on other cost basis as applicable to a particular implantation. For example, media publishers may receive revenue based on unique impressions based on completed views, completed plays, and/or completed duration thresholds.

A unique player is defined as a user that converts (e.g., takes a particular action such as purchase, try on, or otherwise interact with the virtual item or other item that is subject of the piece of digital media) for a particular piece of digital media for the first time. A unique impression is defined as a unique player interacting with the piece of digital media during the experience.

It is also noted that unique media views/impressions may be tracked using the example embodiments described herein. For example, media metrics 214 may include engagement metrics based on engagement with different digital media elements (e.g., such as billboards, doors, portals, etc.). The digital media component 130 or another component may track engagement metrics for digital media.

Some examples of portal and media metrics 214 include different metrics based on types of user views and/or impressions and/or engagement actions. A first metric may count a total number of unique users that joined a virtual experience. For example, if the number goes up for the virtual experience when more pieces of digital media for the virtual experience are displayed by the platform, it may indicate a success rate of the piece of media. A different metric may count a total number of impressions for a particular piece of digital media. For example, if the number of impressions increases or decreases, this change may indicate a measure of success for the piece of digital media. Additionally, media metrics 214 may also include a total number of unique users in each group that joined the virtual experience in a given time period (e.g., one week) and viewed a piece of digital media 216. For example, media metrics 214 may also include the number of total impressions for the piece of media in each group within a time period (e.g., one week).

These and other media metrics may be used to calculate at least a portion of engagement metrics.

Engagement metrics may also be utilized to calculate other media metrics 214, for example, by: average playtime of users for each group, average monetization conversion percentage of users for each group, average revenue per user for each group, and other impacts.

Some examples of media impressions include: a percentage or amount of time spent viewing a piece of media. When considering digital media elements, impressions may be tracked by: determining an angle of incidence or angle of view based upon a perspective of an avatar and distance from a digital media element, through analysis of a viewport or perspective of an avatar, through analysis of an amount of time an avatar is within a threshold distance from a digital media element and within a threshold angle of view, and/or through analysis of a percentage of viewable surface of a piece of media displayed at the digital media element. In some implementations, the minimum time to count as a media impression is one second and the distance between an avatar and the digital media element is close enough (e.g., within the threshold distance) for the avatar to view the piece of digital media and hear the associated audio being displayed at the digital media element. For example, an avatar may view a piece of digital media from an angle such that the piece of media is not visible clearly or is obstructed. This may count for a partial impression or may not count as an impression. For example, an avatar may view a piece of digital media through a viewport which may be analyzed for pixel count or percentage of a piece of digital media that is obfuscated or viewable. This may count for partial impression or may not count as an impression. For example, an avatar may view a piece of media for an amount of time. This may be used to determine time-based metrics.

Hereinafter, several aspects associated with media placement in a virtual experience are provided for clarity of discussion.

### Interactive Media Formats

The online virtual experience platform 100 may serve static ad creatives (e.g., billboards, portals, headers, and others). Billboard and similar static structures may be interactive and/or clickable by avatars, in some implementations. Developers may insert static media elements via a GUI and/or by automatic placement and/or by automatic placement recommendations. The static media elements may have the look and feel of a street billboard or wall, surface, etc. Developers may also use the actual creative image independent of the billboard object to overlay on top of any compatible object in an experience (e.g., side of a building, interior wall, etc.).

Some other media creatives may include, for example: billboards or structures that light up (or include other highlighting features) or spins (or other motion) when a player/avatar steps within a range; clickable image media that can generate a Quick Response (QR) code; interactive media containers that react to player behavior (i.e., a player steps on a colored tile and the borders of the media container change, or other behaviors); clickable media units that can be used by the developer to incorporate into a gameplay based on goals, waypoints, milestones, and other gameplay features; and video-based media units that play looped video, GIF, motion pictures, cartoons, and/or any other video displays that may also be interactive. Audio may be included as part of video playback. Audio may also be incorporated when an avatar is within proximity and/or implemented with spatial audio; a user may search out an interactive element based on spatial audio (e.g., highlight and/or become active visually once a user is within proximity or has found the media creative).

Billboards and other ad creatives may be interactive when disposed in a virtual experience. For example, these and other media units can become interactive based on the following examples of user engagement: Player/avatar travels within proximity of ad unit; Player/avatar “views” the ad unit; Player/avatar can click on the ad unit; and/or geographical position of Player in real life may trigger the ad unit (e.g., with appropriate permissions obtained and other security controls implemented).

The above and other interactions can trigger the following example behaviors:

Sale of virtual items: the sales may be effectuated through a new media experience that an avatar is transported/teleported to due to interaction with the ad; the sales may be effectuated through a user interface for purchasing products (both virtual and real-world/physical items); the sales may be effectuated through a purchasing experience such as selecting different items in the interactive piece of media and virtually transporting them to a virtual cash register or virtual point of sale; and others.

Sale of real physical items: the sales of physical items may be effectuated through examples similar to those described herein-above with reference to virtual purchases; users may use a secure transaction processing platform or the virtual experience platform (with appropriate permissions and security implemented) to transfer funds for real-world items; and others.

Add events to a calendar or event scheduler of a user: events interacted with and selected may be added automatically (or with a separate prompt/user selection) to a personal calendar or shared calendar or other calendar of a user (with appropriate permission granted to the virtual experience platform); a user may also utilize a calendar service on the virtual experience platform which may automatically include this functionality; a user-selected event may also be emailed to an appropriate user email address such that a user may manually import the emailed event data to a calendar (through attachment of an electronic calendar entry file, event data, or other data); and others.

Add QR code or promo code to virtual wallet: QR codes, promotion codes, promo codes, coupons, and others may be transmitted to a virtual wallet or an e-wallet application of a user; codes may also be emailed to an appropriate user email address; and others.

The online virtual experience platform 100 may also serve pieces of media that are embossed or wrapped onto virtual items. For example, virtual items may be re-skinned to include a logo of a media provider, an emblem of a sport, a logo, a manufacturer name, and other attributes. For example, virtual items may be re-skinned to include popular textures from famous paintings or other similar features. For example, virtual items may be re-painted to include features identifiable as being associated with a product, service, or media provider. Other variations may also be applicable.

### Interactive Media Moderation

Users may report offensive pieces of media. Offensive content reporting links may be rendered for each digital media element for misleading, offensive, or objectionable content. A reporting link may provide a menu for reporting pieces of media that violate content policies. Reports can populate an automatic or administrative moderation queue specifically for media. Media creatives that are submitted can be placed in a media-specific moderation queue. Moderators may use a prioritization framework to ensure that turnaround time for media review is within a particular time period (e.g., 1-2 hours of creative submission, or other suitable periods).

### Viewable Media Impressions

Media impressions may be calculated on the server side or on the client side. There are at least two types of impressions, rendered impressions and viewable impressions. A rendered impression is generated whenever an in-experience piece of media is rendered on the client side, regardless of whether the user has an opportunity to see it. A viewable impression is generated whenever an in-experience piece of media is rendered on the client side and the user has an opportunity to see it. Additionally, a user identification (ID) of a user viewing the piece of media, a timestamp, a container ID, and other data may also be recorded. Furthermore, lighting of the piece of media, motion of an avatar, motion of the piece of media, and other dynamic features may be used in calculating impressions.

In some implementations, ray-casting may be used to determine full or partial impressions. The ray may be cast from an avatar onto the piece of media, in some implementations. In some implementations, the ray may be cast from the piece of media onto the target avatar.

In some implementations, random ray-casting may be used to determine full or partial impressions and/or ad obstruction percentages. The random ray may be cast from an avatar or a viewport onto the piece of media. The random ray cast may be repeated for a window of time, such that a number of random rays are cast. The accumulation of non-obstructed random rays may be used to determine a percentage of obstruction.

In some implementations, various viewable ad data including screenshots, viewports, perspectives, and other data may be captured for auditing of ad impressions and revenue. For example, viewports from a view of a user may be used to verify and/or audit ad impressions. For example, screenshots from a perspective of a user may be used to verify and/or audit ad impressions. Other data may also be captured from a user perspective, or from a perspective of an interactive piece of media, to verify and/or audit media impressions.

### Minimum Distance Between Interactive Digital Pieces of Media

To avoid overly monetized experiences, there may be enforced a minimum distance between media elements placed in an experience. For example, a minimum distance of 100 meters (roughly the length of a football field) between pieces of media may be a default minimum distance in some implementations.

These (e.g., interactive media formats, interactive media moderation, viewable media impressions, and minimum distance) and other considerations may be considered when determining automatic media placement by the digital media component 130. Furthermore, the heatmap 208 may be further augmented with any of the accumulated media metrics 214 (and interactive media formats, interactive media moderation, viewable media impressions, and minimum distance) that are associated with avatar orientations and/or positioning. In this manner, replacement of some pieces of media may be automated based on expected impressions as determined by the digital media component 130 and based upon the heatmap 208.

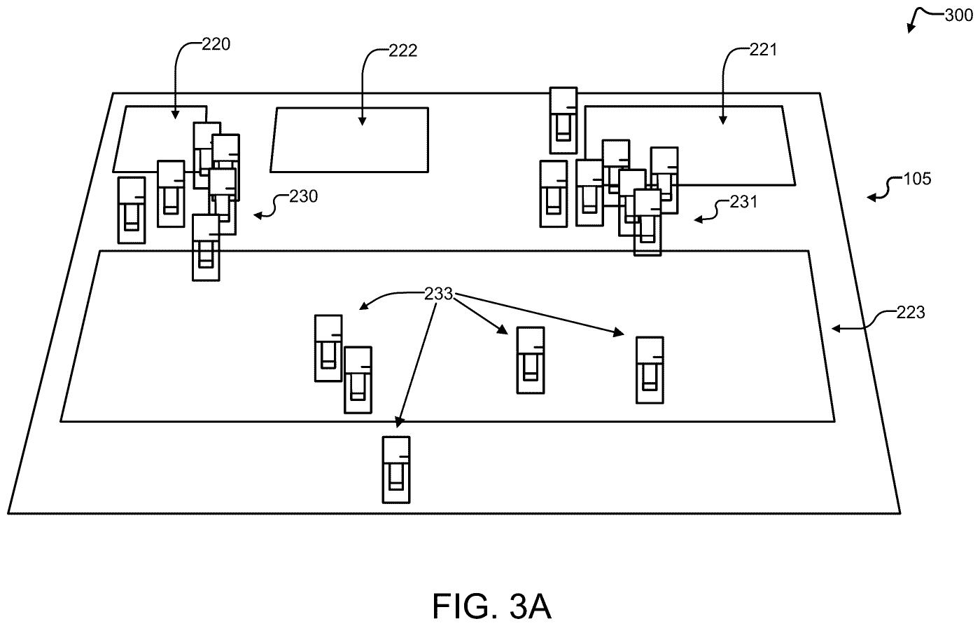

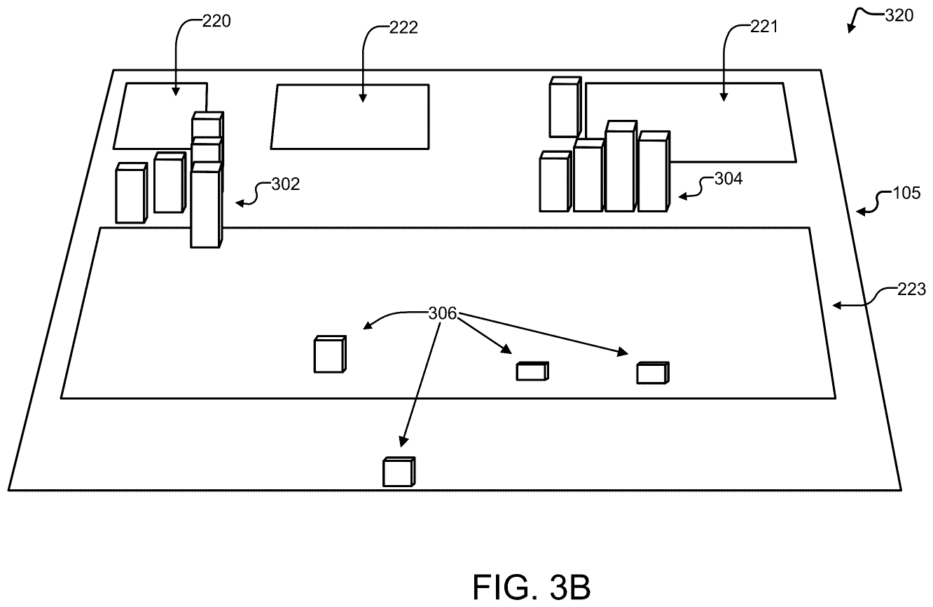

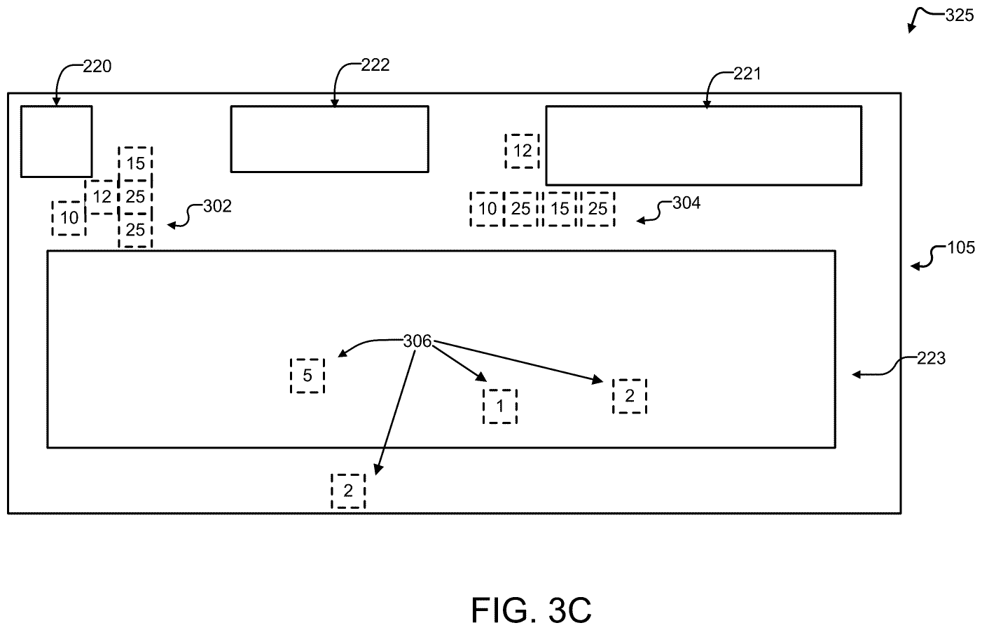

Hereinafter, example visualizations and configurations of the heatmap 208 is described in detail below with reference to FIGS. 3A-3C.

### Heat Maps for Digital Media Insertion

FIG. 3A is an isometric view of a virtual environment 300 of a virtual experience 105, in accordance with some implementations. As illustrated, the virtual environment of VE 105 may include subsections 220, 221, 222, and 223. Each subsection may include any variety of virtual elements, walls, buildings, roads, pathways, and other virtual elements.

During execution and rendering of the VE 105 at an appropriate virtual experience application 112, individual avatars shown as groups 230, 231, and/or 233 may be rendered. Each avatar of the different avatar groups 230, 231, and 233 may include different profile data, demographic data, and others, and such data may be associated with unique IDs that can be tracked along with spatial telemetry data.

During execution of the VE 105, associated spatial telemetry data for each individual avatar may be tracked in order to assemble at least a partial heatmap, as described above with reference to FIG. 2. For example, individual movements, camera angles, view sizes, and others, may be tracked for the avatar groups 230, 231, and 233. The tracked data may be aggregated based on closest voxel and associated with the heatmap or portion thereof. For example, FIG. 3B illustrates a heatmap generated based on the example shown in FIG. 3A.

FIG. 3B is an isometric view of a heatmap 320 based on the virtual environment 300 of FIG. 3A, in accordance with some implementations. As illustrated, voxels 302, 304, 306 are rendered onto a representation of the VE 105, such that sizes of groups (e.g., based on height or another dimension of the voxels) as well as intensity (e.g., based on an opacity or gradient of color of each voxel) can be accurately displayed. In this example, each illustrated voxel represents data for that voxel for a particular time window or time-slice. Therefore, as avatar interact with the VE 105 during the time window and provide spatial telemetry data, the intensity and/or weight of each voxel as well as the voxel size may increase or decrease.

While the view shown in FIG. 3B is an isometric or three-dimensional (3D) representation, other planar representations such as bar graphs, planar maps, and others may also be applicable for heat maps. For example, FIG. 3C illustrates an example two-dimensional (2D) heatmap representation.

FIG. 3C is a planar view of the heatmap of FIG. 3B, in accordance with some implementations. As illustrated, voxel sizes may be rendered as numerical values while intensity may be represented by a color gradient or color intensity. Alternatively, voxel intensity may be represented with numerical values and voxel sizes (e.g., heights or another dimension) may also be represented with numerical values (not illustrated). Other variations including utilizing different color gradients, different rendering intensities, and others, may also be applicable in some implementations.

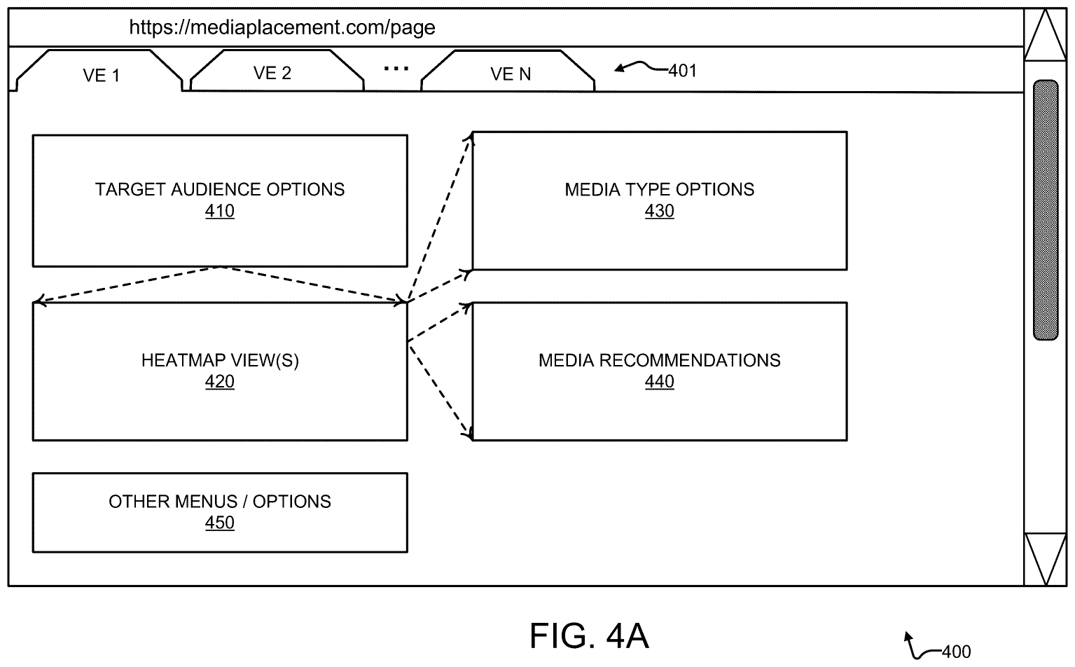

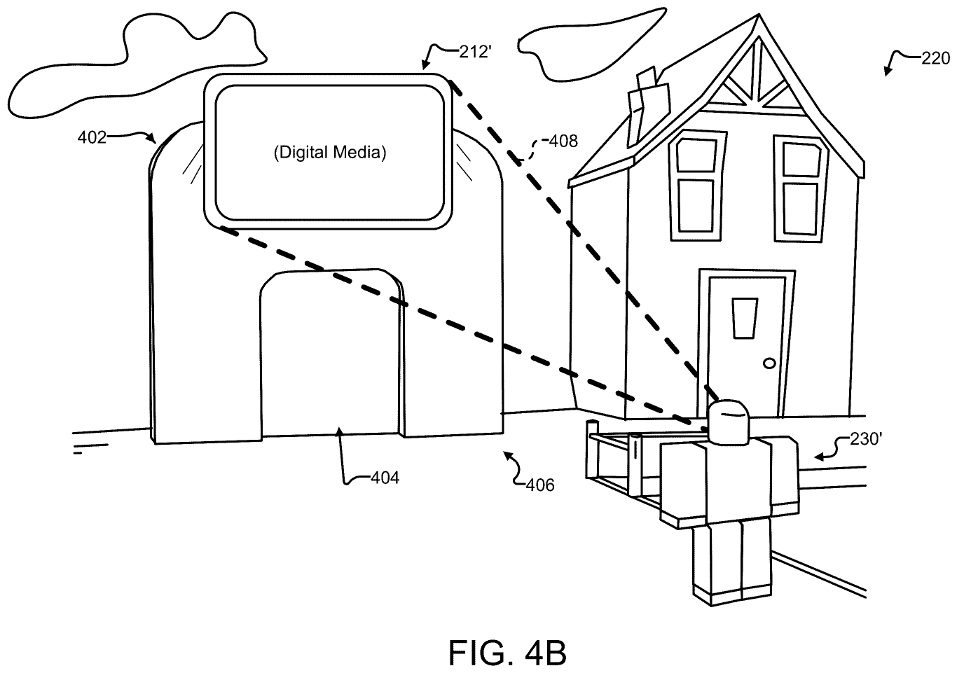

Hereinafter a more detailed description of digital media recommendations and placement based on the generated heatmaps is provided with reference to FIGS. 4A-4B.

### Automatic Digital Media Recommendations and Placement

FIG. 4A is a schematic of a graphical user interface (GUI) 400 for automatic digital media placement, in accordance with some implementations. It is noted that the GUI 400 is illustrated in a simplified manner for clarity in illustration, and any implementation may differ in level of detail and/or fidelity of presentation.

The GUI 400 may include one or more selectable sections 401 that denote a particular virtual experience to which to place a piece of digital media. For example, the GUI 400 has been illustrated as presenting the interface for automatic media placement for VE 1 (e.g., similar to VE 105).

Different target audience options 410 may be selectable by an media provider or developer to indicate preferences. For example, target audience options may include, but are not limited to, minimum or maximum age thresholds, minimum or maximum gameplay hours, min/max number of cohort members, target demographics, and/or other options.

Upon selection (or automatically if no options are selected), one or more heatmap views 420 of a heatmap representing the VE 1 may be displayed and may also be selectable. For example, the heatmap 320 of FIG. 3B may be displayed. Upon display, a media provider or developer may select the highest-ranked voxels, most intense voxels, and/or recommended voxels for media placement that may be highlighted by the digital media components 130 on the displayed heatmap.

Different automatic media options 430 (e.g., ad types, static ad options, video ad options, and others) may be rendered for any selected voxel. Additionally, media recommendations 440 (e.g., recommended ad type and/or media content) may also be displayed. Upon selection (or in an automatic manner if no selection is made) media recommendations 440 may be deployed at the VEI according to the heatmap and associated media aspects (e.g., media profile data, demographic data, etc.) for display to different avatars.

Additional options and menus may be provided at element 450, for example. Examples of additional options and menus may include any media-related options, media profile options, ad campaign options, any demographic or user-related options, as well as others.

FIG. 4B is a perspective view of an automatically placed and tracked digital media element, in accordance with some implementations. It is noted that the description provided in reference to FIG. 4B is illustrative only, and not limiting. For example, actual appearance of a digital media element may be varied in many ways. Furthermore, the number, types, and displayed media may be altered in many ways. Moreover, the simplified schematic shown is for illustrative purposes only, and does not encompass all variations which may be applicable to example embodiments.

As shown in FIG. 4B, the digital media element 406 may comprise a display member 212′ configured to display a piece of digital media 212 based upon approach and with appropriate avatar context of avatar 230′. The digital media element 406 may have been automatically placed in subsection 220 of the VE 105, based upon heatmap 208 data and any other considerations, such as an media profile or targeted demographics. Upon approach by the avatar 230′, the piece of digital media 212 may be displayed and an impression may be calculated based on a view of the avatar 408. Furthermore, in some implementations where an interactive portal 404 is deployed, the avatar 230′ may be transported upon crossing a threshold of the portal 404 into another experience, and media metric may be calculated for the experience in addition to metrics associated with any displayed piece of media on the face 402 of the portal 404. Other variations in types of media (e.g., static media, video-based media, audio-based media, etc.) may also be applicable, and the example shown in FIG. 4B is intended to depict one possible automatic media placement.

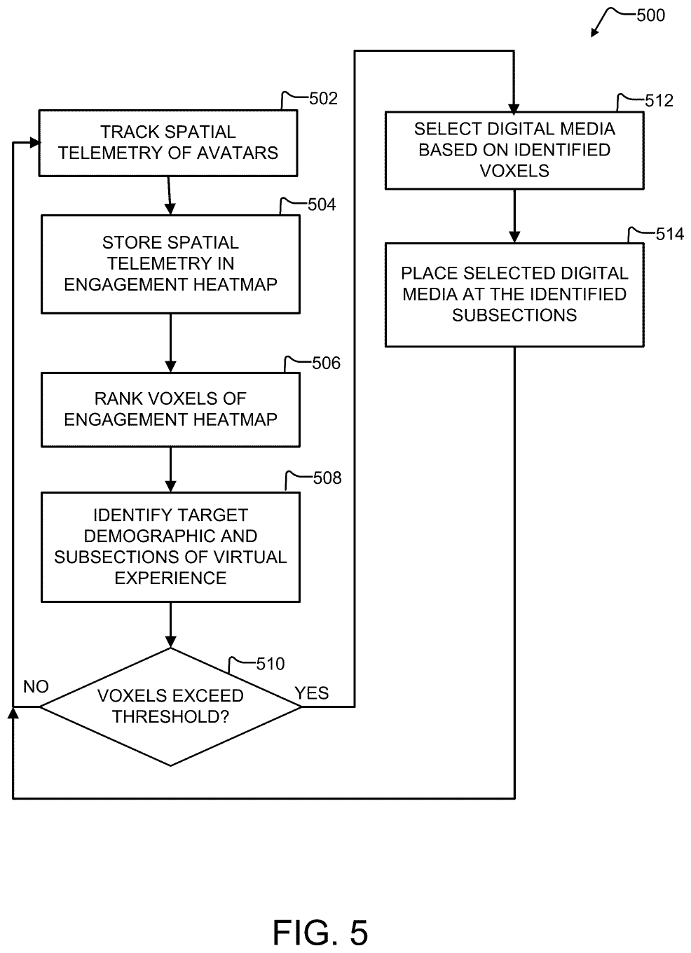

Hereinafter, methods of interactive digital media placement are described more fully with reference to FIG. 5.

### Method of Automatic Digital Media Placement and Tracking

FIG. 5 is a flowchart of an example method 500 of automatic digital media placement, in accordance with some implementations.

In some implementations, method 500 can be implemented, for example, on a server 102 described with reference to FIG. 1 and FIG. 2. In some implementations, some or all of the method 500 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can send results or data to the first device.

In some implementations, the method 500, or portions of the method, can be initiated automatically by a system. In some implementations, the implementing system is a first device. For example, the method (or portions thereof) can be periodically performed, or performed based on one or more particular events or conditions, e.g., a time since last piece of media exceeding a threshold, a number of transports exceeding a threshold, a predetermined time period having expired since the last performance of method 500 for a particular medial item or user, and/or one or more other conditions occurring which can be specified in settings read by the method.

Method 500 may begin at block 502. At block 502, spatial telemetry of a plurality of avatars within a virtual experience is tracked. For example, the tracking may occur during a defined time slice of a time window. The time window and time-slice may each be sized according to play history (e.g., slower progressing experiences may require larger time windows or broader time slices), according to target demographics (e.g., less-experienced or novice players may progress at a different pace and require a different time slice than more advanced players), or according to other considerations, including pre-defined slices based on fixed time windows. In some implementations, the tracking is based upon a first time window of a first size, and each time slice is of a smaller size than the first size. Furthermore, the time window may extend for a threshold number of time slices, in some implementations. Block 502 may be followed by block 504.

At block 504, the tracked spatial telemetry may be stored in an engagement heatmap. For example, the tracked spatial telemetry data may be stored at individual time-slices of the time window. The spatial telemetry data may be stored or aggregated in a plurality of three-dimensional (3D) voxels. For example, each voxel may correspond with a respective subsection of the virtual experience.

In some implementations, the stored spatial telemetry data comprises, for each voxel, a voxel size value that represents a number of individual avatars having spatial telemetry data associated with a particular voxel, and a voxel intensity value that represents a magnitude of spatial telemetry data associated with the particular voxel. The voxel size may be a height of a voxel, in some implementations. The voxel intensity value may be a numerical value such as a weight, in some implementations. Block 504 may be followed by block 506.

At block 506, individual voxels of the engagement heatmap may be ranked. For example, voxels may be ranked according to respective voxel sizes and respective intensity values. Furthermore, individual portions of spatial telemetry data may be used for ranking, such as ranking based on an overall direction of view, an overall field or size of view, and other considerations. Block 506 maybe followed by block 508.

At block 508, a target demographic and individual subsections of the VE 105 trafficked by the target demographic may be identified in the engagement heatmap. For example, a target demographic may be optionally selected by a developer or media provider, or may be based upon available digital media descriptions. The target demographic data may be stored in the heatmap during spatial telemetry data storage, in some implementations. Furthermore, locations of the voxels correspond to locations within the VE 105. Block 508 may be followed by block 510.

At block 510, voxels exceeding an engagement threshold based on the ranked induvial voxels and target demographic are identified. If one or more voxels exceed the thresholds, block 510 is followed by block 512; else, block 510 is followed by block 502 where additional telemetry tracking occurs.

At block 512, a piece of digital media is automatically selected for placement in the virtual experience. For example, automatic selection may be based on a comparison of demographics associated with the ranked voxels as well as any available media profile. Automatic selection may also be based on developer options, such as options described above with reference to GUI 400. Block 512 may be followed by block 514.

At block 514, the selected piece of digital media is automatically placed at the identified subsection. For example, the selected piece of digital media is placed for viewing by the target demographic and placed near, proximate to, or in the location of the identified voxels. Furthermore, orientation of the selected piece of digital media may be based on stored telemetry data, such that avatars are more likely to view the piece of media based on tracked approaches, camera angles, and motion.

Blocks 502-514 can be performed (or repeated) in a different order than described above and/or one or more blocks can be omitted and/or one or more additional functions may be added. For example, blocks 502-510 may be performed repeatedly as avatars engage with the virtual experience but before thresholds are exceeded. Furthermore, portions of the method 500 may be combined and performed in sequence or in parallel, according to specific implementations.

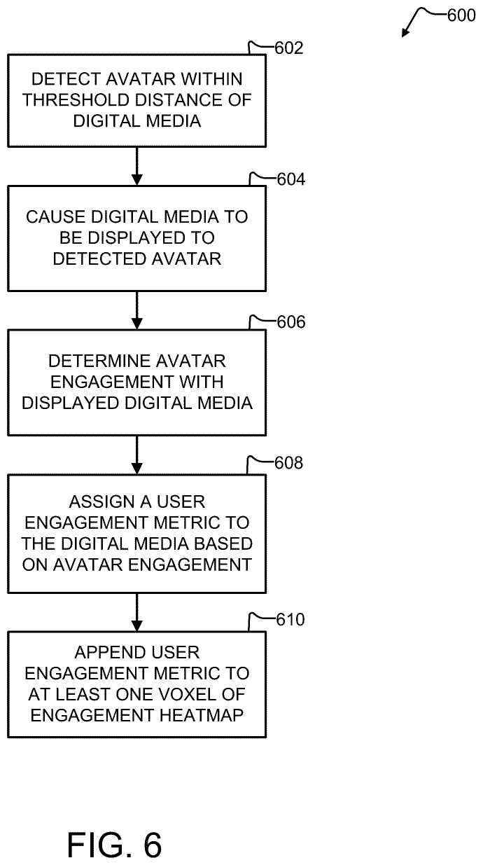

Hereinafter, methods of determining digital media metrics based on interaction or avatar context are described with reference to FIG. 6.

### Determining Digital Media Engagement Metrics

FIG. 6 is a flowchart of an example method 600 of digital media display and engagement tracking, in accordance with some implementations.

In some implementations, method 600 can be implemented, for example, on a server 102 described with reference to FIG. 1 and FIG. 2. In some implementations, some or all of the method 600 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 600. In some examples, a first device is described as performing blocks of method 600. Some implementations can have one or more blocks of method 600 performed by one or more other devices (e.g., other client devices or server devices) that can send results or data to the first device.

In some implementations, the method 600, or portions of the method, can be initiated automatically by a system. In some implementations, the implementing system is a first device. For example, the method (or portions thereof) can be periodically performed, or performed based on one or more particular events or conditions, e.g., a time since last piece of media exceeding a threshold, a number of transports exceeding a threshold, a predetermined time period having expired since the last performance of method 600 for a particular medial item or user, and/or one or more other conditions occurring which can be specified in settings read by the method.

Method 600 may begin at block 602. At block 602, an avatar is detected within a threshold distance of an automatically placed piece of digital media. For example, the threshold distance of the piece of digital media is a configurable distance based upon a total number of pixels of the piece of digital media. In some implementations, detecting the avatar within the threshold distance includes determining that the avatar is within the threshold distance associated with the piece of digital media. For example, the piece of digital media may include media preferences as described above, and the preferences may include a minimum activation distance or another threshold. Other variations may also be applicable. For example, user preferences may require differing levels of interaction prior to displaying media (e.g., require direct interaction with a media element prior to playing back video, require an avatar to select “zoom” prior to display, etc.). Block 602 may be followed by block 604.

At block 604, the piece of digital media may be presented to the avatar. For example, if digital video is part of the piece of media, then block 604 may include playback of the digital video-based media. For example, if a basic piece of media or default view is initially displayed, then a targeted view may be displayed upon avatar approach or detection of the avatar within the threshold distance. Other variations may also be applicable. Block 604 may be followed by block 606.

At block 606, the engagement of the avatar with the presented piece of digital media is tracked by the digital media component 130 or another component of the platform 100. The engagement is based upon one or more of: tracking head movements and viewports associated with the avatar, viewpoint, perspective, time spent viewing, size of view, obfuscation of view, or distance from the piece of media. Other engagement metrics may also be applicable.

In some implementations, avatar movements are tracked to determine the engagement of the avatar. In some implementations, the tracking may include determining a percentage of pixels associated with the piece of digital media that are viewable by the avatar. In some implementations, the piece of digital media is paused or “turned off” if an avatar looks away, then resumes automatically once the avatar views the digital media element again. Other variations may also be applicable.

The digital media component 130 may record and/or store these and other interactions for determining user engagement metrics, media impressions, and other media metrics. The metrics may be recorded and user input may be received (if an avatar directly clicks, for example). Block 606 may be followed by block 608.

At block 608, user engagement metrics for the displayed piece of digital media based upon tracking of the engagement of the avatar are assigned to the displayed piece of digital media. For example, the digital media component may store engagement metrics associated with different piece of media for use in determining valid impressions as described in detail above. The engagement metrics may inform future media placement, preferences, target audiences, target demographics, target devices (e.g., if a piece of media was too slow for some devices, or too rapid for modern devices, etc.), and others. Block 608 may be followed by block 610.

At block 610, the user engagement metrics may be appended to an associated voxel. For example, user engagement metrics associated the displayed piece of digital media may be associated with the spatially-proximate voxel, for future or further heatmap data in relation to the method 500 or other methods. In some implementations, user engagement metrics may be assigned to a heatmap, a particular piece of digital media, or a combination of both. Other variations may also be applicable.

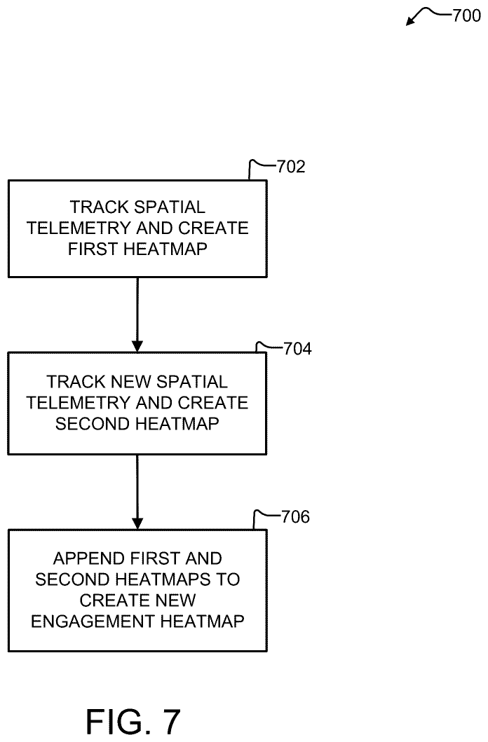

Hereinafter, methods of appending multiple partial heatmaps are described with reference to FIG. 7.

Heatmap Data Streaming and/or Augmentation

FIG. 7 is a flowchart of an example method 700 of heatmap data streaming and/or augmentation, in accordance with some implementations.

In some implementations, method 700 can be implemented, for example, on a server 102 described with reference to FIG. 1 and FIG. 2. In some implementations, some or all of the method 700 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other client devices or server devices) that can send results or data to the first device.

In some implementations, the method 700, or portions of the method, can be initiated automatically by a system. In some implementations, the implementing system is a first device. For example, the method (or portions thereof) can be periodically performed, or performed based on one or more particular events or conditions, e.g., a time since last piece of media exceeding a threshold, a number of transports exceeding a threshold, a predetermined time period having expired since the last performance of method 700 for a particular medial item or user, and/or one or more other conditions occurring which can be specified in settings read by the method.

Method 700 may begin at block 702. At block 702, spatial telemetry is tracked and a first portion of a heatmap is created. For example, the first portion of the heatmap may include a partially created heatmap, a heatmap of only a subsection of a virtual experience, or another sub-portion of a heatmap. The first portion of the heatmap may also include a portion of a heatmap associated with a first demographic, a first target group of avatars, or another sub-portion of data. Block 702 may be followed by block 704.

At block 704, spatial telemetry is tracked and a second portion of a heatmap is created. For example, the second portion of the heatmap may include a partially created heatmap, a heatmap of only a subsection of a virtual experience, or another sub-portion of a heatmap. The second portion of the heatmap may also include a portion of a heatmap associated with a second demographic, a second target group of avatars, or another sub-portion of data. Block 704 may be followed by block 706.

At block 706, the first portion of the heatmap and the second portion of the heatmap may be appended to create a new heatmap. For example, dimensions of individual voxels may be summed, and individual weights or intensities may be combined, at block 706. For example, if dealing with different sub-areas of a virtual experience, the first portion of the heatmap and the second portion of the heatmap may be joined or concatenated. Other variations of combining the two portions of the heatmap may also be applicable.

It is noted that blocks 702-706 may be repeated for any number of sub-portions or individual heatmaps. For example, as voxel dimensions and voxel intensities are easily combined, and multiple heatmaps related to different areas of a virtual experience are also easily combined, multiple different types of sub-portions may be combined in the method 700 resulting in a larger or more defined heatmap upon combination. These and other variations are within the scope of this disclosure.

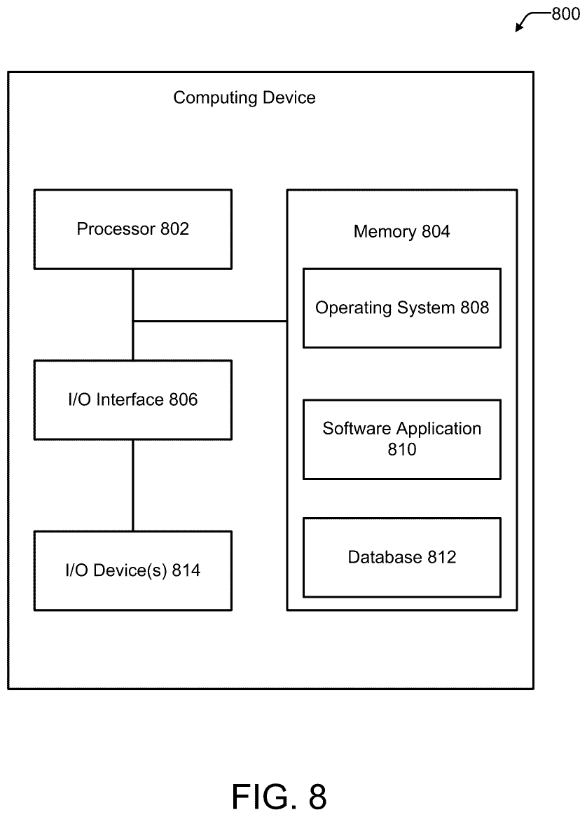

Hereinafter, a more detailed description of various computing devices that may be used to implement different devices and/or components illustrated in FIGS. 1-2 is provided with reference to FIG. 8.

### Computing Devices

FIG. 8 is a block diagram of an example computing device 800 which may be used to implement one or more features described herein, in accordance with some implementations. In one example, device 800 may be used to implement a computer device, (e.g., 102, 110 of FIG. 1 and FIG. 2), and perform appropriate operations as described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 814 (e.g., display screen, touchscreen, display goggles or glasses, audio speakers, headphones, microphone, etc.).

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, software application 810 and associated data 812. In some implementations, the applications 810 can include instructions that enable processor 802 to perform the functions described herein, e.g., some or all of the methods of FIG. 5, FIG. 6, and FIG. 7. Software application 810 may include some or all of the functionality required to present interactive digital media. In some implementations, one or more portions of software application 810 may be implemented in dedicated hardware such as an application-specific integrated circuit (ASIC), a programmable logic device (PLD), a field-programmable gate array (FPGA), a machine learning processor, etc. In some implementations, one or more portions of software application 810 may be implemented in general purpose processors, such as a central processing unit (CPU) or a graphics processing unit (GPU). In various implementations, suitable combinations of dedicated and/or general purpose processing hardware may be used to implement software application 810.

For example, software application 810 stored in memory 804 can include instructions for retrieving user data, for displaying/presenting interactive digital media, and/or other functionality or software such as the digital media component 130, VE Engine 104, and/or VE Application 112. Any of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 108), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

For case of illustration, FIG. 8 shows one block for each of processor 802, memory 804, I/O interface 806, software blocks 808 and 810, and database 812. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can also implement and/or be used with features described herein.

Example user devices can be computer devices including some similar components as the device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 814, for example, can be connected to (or included in) the device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 500, 600, 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain implementations discussed herein may obtain or use user data (e.g., user demographics, user behavioral data, user contextual data, user settings for media, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, an identity of a user may be modified (e.g., by substitution using a pseudonym, numeric value, etc.) so that no personally identifiable information can be determined. In another example, a geographic location of a user may be generalized to a larger region (e.g., city, zip code, state, country, etc.).

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method of presenting digital media within a virtual experience provided at a virtual experience platform, the method comprising:
tracking spatial telemetry of a plurality of avatars within the virtual experience during a time window;
storing spatial telemetry data of the tracked spatial telemetry at individual time-slices of the time window in an engagement heatmap, wherein
the engagement heatmap comprises a data structure comprising a plurality of three-dimensional (3D) voxels, each voxel corresponding with a respective subsection of the virtual experience, and
the stored spatial telemetry data comprises, for each voxel:
a voxel size value that represents a number of individual avatars having spatial telemetry data associated with a particular voxel, and
a voxel intensity value that represents a magnitude of spatial telemetry data associated with the particular voxel;
ranking individual voxels of the engagement heatmap based on a respective voxel size value and a respective voxel intensity value;
identifying a target demographic and individual subsections of the virtual experience trafficked by the target demographic based on the engagement heatmap;
identifying individual voxels that exceed an engagement threshold based on the ranked individual voxels and the identified target demographic;
automatically selecting digital media for placement in the virtual experience and viewable by the identified target demographic based on the identified individual voxels; and
placing the selected digital media at the identified individual subsections of the virtual experience, wherein members of the target demographic are associated with a respective member avatar in the virtual experience, and wherein the placing is performed at a time outside the time window.

2. The computer-implemented method of claim 1, further comprising:
detecting that the member avatar is within a threshold distance of a first piece of digital media content of the placed selected digital media;
causing the first piece of digital media content to be displayed in the virtual experience while the member avatar is within the threshold distance;
determining engagement of the member avatar with the first piece of digital media based on interaction between the member avatar and the first piece of digital media in the virtual experience;
assigning a user engagement metric to the first piece of digital media based on the engagement; and
appending the user engagement metric to at least one voxel of the engagement heatmap as a voxel engagement value, wherein the at least one voxel is within the identified individual subsections of the virtual experience.

3. The computer-implemented method of claim 1, wherein the individual time-slices are evenly distributed time-slices of the time window, and include at least two time-slices.

4. The computer-implemented method of claim 1, wherein the engagement heatmap is a first engagement heatmap, wherein the time window is a first time window, and wherein the computer-implemented method further comprises:
tracking spatial telemetry of a plurality of avatars within the virtual experience during a second time window; and
storing spatial telemetry data of the tracked spatial telemetry at individual time-slices of the second time window in a second engagement heatmap.

5. The computer-implemented method of claim 4, further comprising:
appending the second engagement heatmap to the first engagement heatmap to obtain a new engagement heatmap; and
updating placement of the selected digital media based on the new engagement heatmap.

6. The computer-implemented method of claim 4, further comprising:
appending the second engagement heatmap to the first engagement heatmap to obtain a new engagement heatmap; and
replacing the placed selected digital media by:
ranking individual voxels of the new engagement heatmap based on a respective voxel size value and a respective voxel intensity value;
identifying a new target demographic and new individual subsections of the virtual experience trafficked by the new target demographic based on the new engagement heatmap;
identifying new individual voxels that exceed the engagement threshold based on the ranked individual voxels and the identified new target demographic;
automatically selecting new digital media for placement in the virtual experience and viewable by the new identified target demographic based on the new identified individual voxels; and
placing the selected new digital media at the identified new individual subsections of the virtual experience.

7. The computer-implemented method of claim 1, wherein the stored spatial telemetry data further comprises one or more of: a camera view value that represents camera view size of a respective avatar; a camera orientation value that represents a camera orientation of a respective avatar; a demographic value that represents a respective demographic of a user of the virtual experience platform associated with a respective avatar; a social value that represents social connections of a respective avatar; a user type value that represents a type of user associated with a respective avatar; context data that represents a context of engagement of a respective avatar within the virtual experience; and combinations thereof.

8. The computer-implemented method of claim 1, further comprising:
presenting, at a user interface, the engagement heatmap as a graphic with selectable elements associated with the identified individual subsections of the virtual experience; and
displaying, based on received selections of the selectable elements, spatial telemetry data associated with individual voxels corresponding to the identified individual subsections of the virtual experience.

9. The computer-implemented method of claim 8, further comprising:
altering the placed selected digital media based on the received selections of the selectable elements.

10. The computer-implemented method of claim 8, wherein placing the selected digital media is further based on the received selections of the selectable elements.

11. A system, comprising:
a memory with instructions stored thereon; and
one or more processing devices, coupled to the memory, the one or more processing devices configured to access the memory and execute the instructions to perform operations including:
tracking spatial telemetry of a plurality of avatars within a virtual experience during a time window;
storing spatial telemetry data of the tracked spatial telemetry at individual time-slices of the time window in an engagement heatmap, wherein
the engagement heatmap comprises a data structure comprising a plurality of three-dimensional (3D) voxels, each voxel corresponding with a respective subsection of the virtual experience, and
the stored spatial telemetry data comprises, for each voxel:
a voxel size value that represents a number of individual avatars having spatial telemetry data associated with a particular voxel, and
a voxel intensity value that represents a magnitude of spatial telemetry data associated with the particular voxel;
ranking individual voxels of the engagement heatmap based on a respective voxel size value and a respective voxel intensity value;
identifying a target demographic and individual subsections of the virtual experience trafficked by the target demographic based on the engagement heatmap;
identifying individual voxels that exceed an engagement threshold based on the ranked individual voxels and the identified target demographic;
automatically selecting digital media for placement in the virtual experience and viewable by the identified target demographic based on the identified individual voxels; and
placing the selected digital media at the identified individual subsections of the virtual experience, wherein members of the target demographic are associated with a respective member avatar in the virtual experience, and wherein the placing is performed at a time outside the time window.

12. The system of claim 11, wherein the operations further comprise:
detecting an avatar of the plurality of avatars within a threshold distance of a first piece of digital media content of the placed selected digital media, the avatar being associated with a user, wherein the user is associated with the identified target demographic;
presenting the first piece of digital media content for viewing by the avatar;
tracking an engagement of an avatar with the presented first piece of digital media content, wherein the engagement of the avatar is a measure of an interaction of the avatar with the presented first piece of digital media content;
assigning a user engagement metric to the presented first piece of digital media content based upon the tracking of the engagement of the avatar; and
appending the user engagement metric to at least one voxel of the engagement heatmap as a voxel engagement value.

13. The system of claim 11, wherein the individual time slices are evenly distributed time slices of the time window.

14. The system of claim 11, wherein the engagement heatmap is a first engagement heatmap, wherein the time window is a first time window, and wherein the operations further comprise:
tracking spatial telemetry of a plurality of avatars within the virtual experience during a second time window; and
storing spatial telemetry data of the tracked spatial telemetry at individual time-slices of the second time window in a second engagement heatmap.

15. The system of claim 14, wherein the operations further comprise:
appending the second engagement heatmap to the first engagement heatmap to create a new engagement heatmap; and
arranging the selected digital media for automatic viewing by members of the target demographic based on the new engagement heatmap.

16. The system of claim 14, wherein the operations further comprise:
appending the second engagement heatmap to the first engagement heatmap to create a new engagement heatmap; and
replacing the placed selected digital media by:
ranking individual voxels of the new engagement heatmap based on a respective voxel size value and a respective voxel intensity value;
identifying a new target demographic and new individual subsections of the virtual experience trafficked by the new target demographic based on the new engagement heatmap;
identifying new individual voxels that exceed the engagement threshold based on the ranked individual voxels and the identified new target demographic;
automatically selecting new digital media for placement in the virtual experience and viewable by the new identified target demographic based on the new identified individual voxels; and
placing the selected new digital media at the identified new individual subsections of the virtual experience.

17. The system of claim 11, wherein the stored spatial telemetry data further comprises one or more of: a camera view value that represents a camera view size of a respective avatar; a camera orientation value that represents a camera orientation of a respective avatar; a demographic value that represents a user demographic of a respective avatar; a social value that represents social connections of a respective avatar; a user type value that represents a type of user associated with a respective avatar; and context data that represents a context of engagement of a respective avatar within the virtual experience.

18. The system of claim 11, wherein the operations further comprise:
presenting, at a user interface, the engagement heatmap as a graphic with selectable elements associated with the identified individual subsections of the virtual experience; and
displaying, based on received selections of the selectable elements, spatial telemetry data associated with individual voxels corresponding to the identified individual subsections of the virtual experience.

19. The system of claim 18, wherein the operations further comprise:
altering the placed selected digital media based on the received selections of the selectable elements.

20. A non-transitory computer-readable medium with instructions stored thereon that, responsive to execution by a processing device, causes the processing device to perform operations comprising:
tracking spatial telemetry of a plurality of avatars within a virtual experience during a time window;
storing spatial telemetry data of the tracked spatial telemetry at individual time-slices of the time window in an engagement heatmap, wherein
the engagement heatmap comprises a data structure comprising a plurality of three-dimensional (3D) voxels, each voxel corresponding with a respective subsection of the virtual experience, and
the stored spatial telemetry data comprises, for each voxel:
a voxel size value that represents a number of individual avatars having spatial telemetry data associated with a particular voxel, and
a voxel intensity value that represents a magnitude of spatial telemetry data associated with the particular voxel;
ranking individual voxels of the engagement heatmap based on a respective voxel size value and a respective voxel intensity value;
identifying a target demographic and individual subsections of the virtual experience trafficked by the target demographic based on the engagement heatmap;
identifying individual voxels that exceed an engagement threshold based on the ranked individual voxels and the identified target demographic;
automatically selecting digital media for placement in the virtual experience and viewable by the identified target demographic based on the identified individual voxels; and
placing the selected digital media at the identified individual subsections of the virtual experience, wherein members of the target demographic are associated with a respective member avatar in the virtual experience, and wherein the placing is performed at a time outside the time window.
